(19) United States
(12) Patent Application Publication
(10) Pub. No.: US 2016/0292991 A1
(43) Pub. Date: Oct. 6, 2016

(54) Child Safety System

(71) Applicant: Paula Yarbrough, Garland, TX (US)

(72) Inventor: Paula Yarbrough, Garland, TX (US)

(21) Appl. No.: 14/677,079

(22) Filed: Apr. 2, 2015

(51) Int. Cl. G08B 21/24; B60R 21/015

(52) U.S. Cl. CPC G08B 21/24; B60R 21/01556; B60R 2021/0104

(57) ABSTRACT

A child safety system includes a vehicle that has an ignition and a key. A child seat is positioned within the vehicle and a base unit is provided. A clip is attached to the base unit and the clip engages the child seat. An alert is attached to the base unit and the alert emits an audible alarm when the alert receives a trigger signal. Thus, the alert notifies a user that a child is in the child seat when the vehicle is shut off. A remote unit is operationally coupled to the ignition such that the remote unit detects when the vehicle has been shut off. The remote unit generates the trigger signal when the vehicle is shut off.

### BACKGROUND OF THE DISCLOSURE

### Field of the Disclosure

The disclosure relates to safety devices and more particularly pertains to a new safety device for issuing an alert that a child has been left in a vehicle when the vehicle is turned off.

### SUMMARY OF THE DISCLOSURE

An embodiment of the disclosure meets the needs presented above by generally comprising a vehicle that has an ignition and a key. A child seat is positioned within the vehicle and a base unit is provided. A clip is attached to the base unit and the clip engages the child seat. An alert is attached to the base unit and the alert emits an audible alarm when the alert receives a trigger signal. Thus, the alert notifies a user that a child is in the child seat when the vehicle is shut off. A remote unit is operationally coupled to the ignition such that the remote unit detects when the vehicle has been shut off. The remote unit generates the trigger signal when the vehicle is shut off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a child safety system according to an embodiment of the disclosure.

FIG. 2 is a back view of an embodiment of the disclosure.

FIG. 3 is a front view of an embodiment of the disclosure.

FIG. 4 is a left side view of an embodiment of the disclosure.

FIG. 5 is a schematic view of an embodiment of the disclosure.

FIG. 6 is a perspective in-use view of an embodiment of the disclosure.

### DESCRIPTION OF THE PREFERRED EMBODIMENT

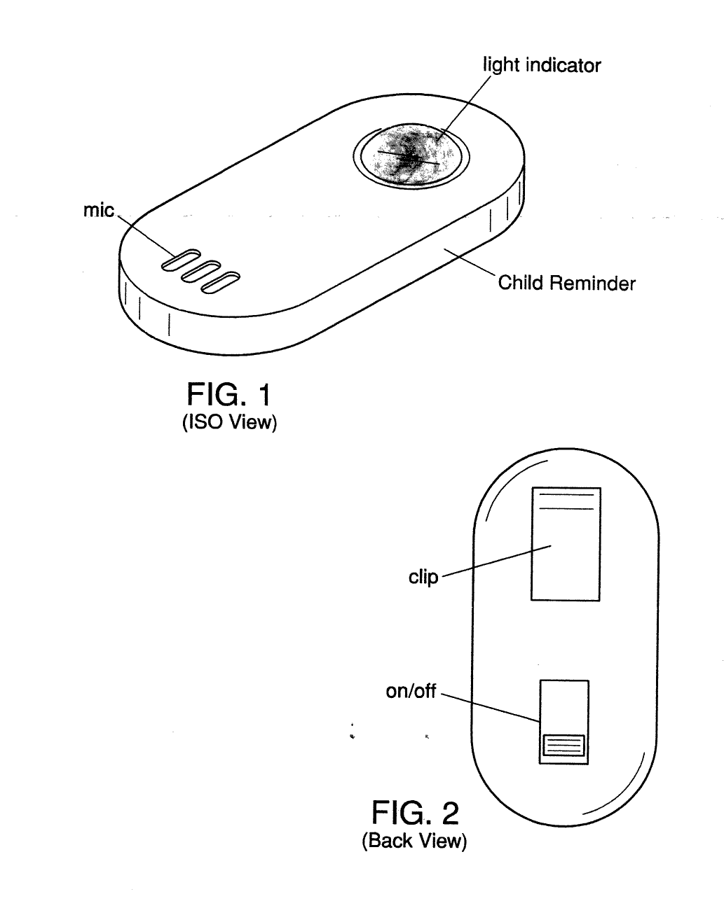

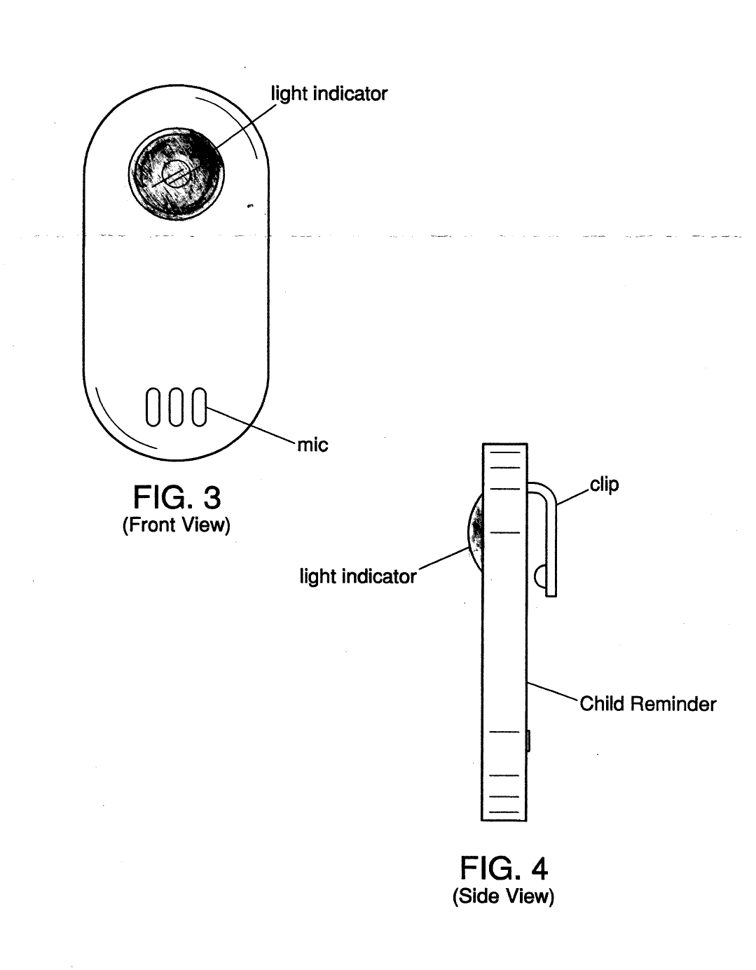

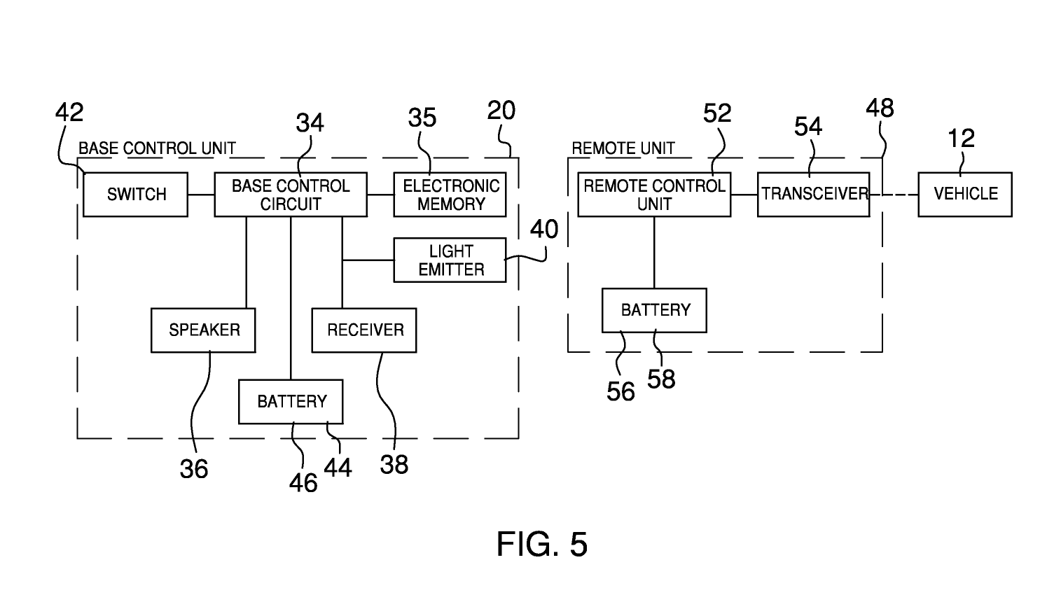

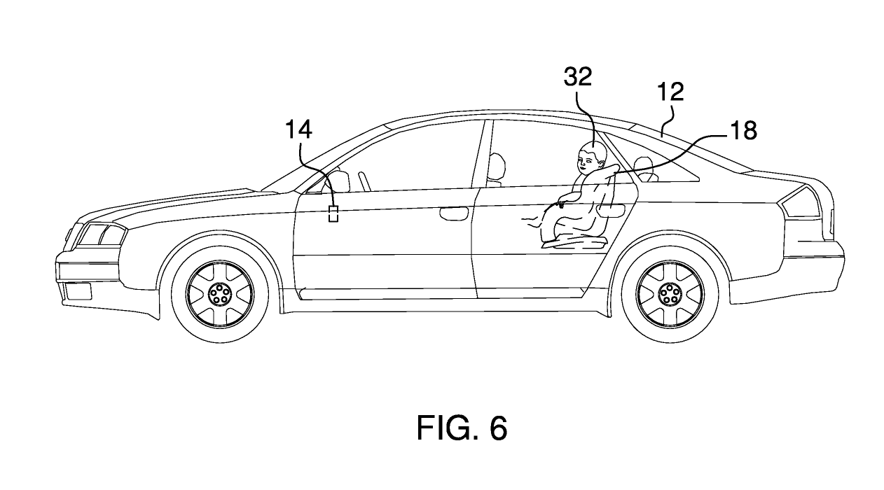

With reference now to the drawings, and in particular to FIGS. 1 through 6 thereof, a new safety device embodying the principles and concepts of an embodiment of the disclosure and generally designated by the reference numeral 10 will be described.

As best illustrated in FIGS. 1 through 6, the child safety system 10 generally comprises a vehicle 12 that has an ignition 14 and a key 16. The vehicle 12 may be a passenger vehicle or the like. A child seat 18 is positioned within the vehicle 12 and the child seat 12 may be a child safety seat of any conventional design. A base unit 20 is provided that has a front side 22, a back side 24 and a peripheral side 26 extending between the front side 22 and the back side 24. A clip 28 is attached to the base unit 20 and the clip 28 is positioned on the back side 24. The clip 28 engages the child seat 18 to retain the base unit 20 on the child seat 18.

An alert 30 is attached to the base unit 20 and the alert 30 emits an audible alarm when the alert 30 receives a trigger signal. Thus, the alert 30 notifies a user that a child 32 is in the child seat 12 when the vehicle 12 is shut off. The alert 30 comprises a base control circuit 34 that is positioned within the base unit 20. An electronic memory 35 is positioned within the base unit 20 and the electronic memory 35 is electrically coupled to the base control circuit 34. The electronic memory 35 stores an audio file. The audio file may comprise the words “Baby on board” and the audio file is pre-loaded into the electronic memory 35. The electronic memory 35 may comprise ROM memory or the like.

A speaker 36 is attached to the base unit 20 and the speaker 36 is positioned on the front side 22 of the base unit 20. The speaker 36 is electrically coupled to the base control circuit 34 such that the speaker 36 selectively emits the audio file. A receiver 38 is positioned within the base unit 20 and the receiver 38 is electrically coupled to the base control circuit 34. The receiver 38 actuates the speaker 36 to emit the audio file when the receiver 38 receives the trigger signal. The receiver 38 may be a radio frequency receiver or the like.

A light emitter 40 is attached to the base unit 20 and the light emitter 40 is positioned on the front side 22 of the base unit 20. The light emitter 40 is electrically coupled to the base control circuit 34 and the light emitter 40 emits light when the receiver 38 receives the trigger signal. The light emitter 40 may comprise an LED or the like and the light emitter 40 may emit red light.

A switch 42 is attached to the base unit 20 and the switch 42 is positioned on the back side 24 of the base unit 20. The switch 42 is electrically coupled to the base control circuit 34 and the switch 42 selectively actuates and de-actuates the base control circuit 34. A base power supply 44 is positioned within the base unit 20 and the base power supply 44 is electrically coupled to the base control circuit 34. The base power supply 44 comprises at least one battery 46.

A remote unit 48 is provided and the remote unit 48 is electrically coupled to the ignition 14 such that the remote unit 48 detects when the vehicle 12 has been shut off. The remote unit 48 generates the trigger signal when the vehicle 12 is shut off. The remote unit 48 comprises a ring 50 that is coupled to the remote unit 48 and the ring 50 is attached to the key 16. A remote control circuit 52 is positioned within the remote unit 48. A transceiver 54 is positioned within the remote unit 48 and the transceiver 54 is in electrical communication with the vehicle 12.

The transceiver 54 is electrically coupled to the remote control circuit 52 and the remote unit 48 detects when the key 14 has been removed from the ignition 14. The transceiver 54 is in electrical communication with the receiver 38 and the transceiver 54 transmits the trigger signal to the receiver 38 when the remote unit 48 detects the key 14 has been removed from the ignition 14. A remote power supply 56 is positioned within the remote unit 48 and the remote power supply 56 is electrically coupled the remote control circuit 52. The remote power supply 56 comprises at least one battery 58.

In use, the clip 28 is attached to the child seat 18 and the ring 50 is attached to the key 16. The child 32 is placed in the child seat 18 and the vehicle 12 is driven. The speaker 36 emits the audio file and the light emitter 40 emits light when the key 16 is removed from the ignition 14. The speaker 36 and the light emitter 40 reduce the likely hood that the child 32 will be left unattended in the vehicle 12 after the vehicle 12 has been driven.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A child safety system configured to issue an alert that a child is in a vehicle when the vehicle has been shut off, said system comprising:
a vehicle having an ignition and a key;
a child seat being positioned within said vehicle;
a base unit;
a clip being attached to said base unit, said clip engaging said child seat;
an alert being attached to said base unit, said alert emitting an audible alarm when said alert receives a trigger signal wherein said alert is configured to notify a user that a child is in said child seat when said vehicle is shut off; and
a remote unit being operationally coupled to said ignition such that said remote unit detects when said vehicle has been shut off, said remote unit generating said trigger signal when said vehicle is shut off.

2. The assembly according to claim 1, wherein said base unit has a front side, a back side and a peripheral side extending between said front side and said back side, said clip being positioned on said back side.

3. The assembly according to claim 1, wherein said alert comprises a base control circuit being positioned within said base unit.

4. The assembly according to claim 3, further comprising an electronic memory being positioned within said base unit, said electronic memory being electrically coupled to said base control circuit, said electronic memory storing an audio file.

5. The assembly according to claim 4, further comprising a speaker being attached to said base unit, said speaker being positioned on said front side, said speaker being electrically coupled to said base control circuit such that said speaker selectively emits said audio file.

6. The assembly according to claim 5, further comprising a receiver being positioned within said base unit, said receiver being electrically coupled to said base control circuit, said receiver actuating said speaker to emit said audio file when said receiver receives said trigger signal.

7. The assembly according to claim 6, further comprising a light emitter being attached to said base unit, said light emitter being positioned on said front side, said light emitter being electrically coupled to said base control circuit, said light emitter emitting light when said receiver receives said trigger signal.

8. The assembly according to claim 7, further comprising a switch being attached to said base unit, said switch being positioned on said back side, said switch being electrically coupled to said base control circuit, said switch selectively actuating and de-actuating said control circuit.

9. The assembly according to claim 8, further comprising a base power supply positioned within said base unit, said base power supply being electrically coupled to said base control circuit, said base power supply comprising at least one battery.

10. The assembly according to claim 1, wherein said remote unit comprises a ring being coupled to said remote unit, said ring being attached to said key.

11. The assembly according to claim 1, further comprising a remote control circuit being positioned within said remote unit.

12. The assembly according to claim 11, further comprising:
a receiver; and
a transceiver being positioned within said remote unit, said transceiver being in electrical communication with said vehicle, said remote unit detecting when said key has been removed from said ignition, said transceiver being electrically coupled to said remote control circuit, said transceiver being in electrical communication with said receiver, said transceiver transmitting said trigger signal to said receiver when said remote unit detects said key has been removed from said ignition.

13. The assembly according to claim 12, further comprising a remote power supply positioned within said remote unit, said remote power supply being electrically coupled said remote control circuit, said remote power supply comprising at least one battery.

14. A child safety system configured to issue an alert that a child is in a vehicle when the vehicle has been shut off, said system comprising:
a vehicle having an ignition and a key;
a child seat being positioned within said vehicle;
a base unit having a front side, a back side and a peripheral side extending between said front side and said back side;
a clip being attached to said base unit, said clip being positioned on said back side, said clip engaging said child seat;
an alert being attached to said base unit, said alert emitting an audible alarm when said alert receives a trigger signal wherein said alert is configured to notify a user that a child is in said child seat when said vehicle is shut off, said alert comprising
a base control circuit being positioned within said base unit,
an electronic memory being positioned within said base unit, said electronic memory being electrically coupled to said base control circuit, said electronic memory storing an audio file,
a speaker being attached to said base unit, said speaker being positioned on said front side, said speaker being electrically coupled to said base control circuit such that said speaker selectively emits said audio file,
a receiver being positioned within said base unit, said receiver being electrically coupled to said base control circuit, said receiver actuating said speaker to emit said audio file when said receiver receives said trigger signal,
a light emitter being attached to said base unit, said light emitter being positioned on said front side, said light emitter being electrically coupled to said base control circuit, said light emitter emitting light when said receiver receives said trigger signal,
a switch being attached to said base unit, said switch being positioned on said back side, said switch being electrically coupled to said base control circuit, said switch selectively actuating and de-actuating said control circuit, and
a base power supply positioned within said base unit, said base power supply being electrically coupled to said base control circuit, said base power supply comprising at least one battery; and
a remote unit being operationally coupled to said ignition such that said remote unit detects when said vehicle has been shut off, said remote unit generating said trigger signal when said vehicle is shut off, said remote unit comprising
a ring being coupled to said remote unit, said ring being attached to said key,
a remote control circuit being positioned within said remote unit,
a transceiver being positioned within said remote unit, said transceiver being in electrical communication with said vehicle, said remote unit detecting when said key has been removed from said ignition, said transceiver being electrically coupled to said remote control circuit, said transceiver being in electrical communication with said receiver, said transceiver transmitting said trigger signal to said receiver when said remote unit detects said key has been removed from said ignition, and
a remote power supply positioned within said remote unit, said remote power supply being electrically coupled said remote control circuit, said remote power supply comprising at least one battery.
